(19) United States
(12) Patent Application Publication
(10) Pub. No.: US 2010/0082894 A1
(43) Pub. Date: Apr. 1, 2010

(54) COMMUNICATION SYSTEM AND METHOS BETWEEN PROCESSORS

(75) Inventors: Chi-Chun HSU, Hsinchu City (TW); Hung-Yen CHEN, Taipei City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INC., Hsin-Chu (TW)

(21) Appl. No.: 12/238,741

(22) Filed: Sep. 26, 2008

(51) Int. Cl. G06F 12/06

(52) U.S. Cl. 711/105; 711/E12.083

(57) ABSTRACT

A system communicating processors is provided. The system comprises a first processor, a second processor, a SRAM and a DMA unit. The DMA unit further comprises a detection unit to determine whether the SRAM is accessed by the second processor, wherein when the SRAM is not accessed by the second processor, the access control of the SRAM is transferred to the DMA unit, and data communication between the first processor and the second processor is transmitted by the DMA unit.

### BACKGROUND OF THE INVENTION

1. Field of the Invention

The invention relates to a communication system, and more particularly to a communication system between processors.

2. Description of the Related Art

Recently, digital signal processing applications use multi-processor computer systems having a host processor in communication with a digital signal processor. In this multi-processor configuration, usually, the host processor is responsible for dealing with input, output and digital signal processing tasks. The digital signal processor is responsible for high speed response task.

A possible problem of such a configuration is communication overhead between the processors. In a typical application, the host processor transmits various data to/from the digital signal processor. An interrupt trigger mechanism or polling mechanism is applied for the communication between the microprocessor and the digital signal processor. Take the optical drive for example, with the increasing of the speed of the optical drive, the bandwidth for the communication between processors is critical.

### BRIEF SUMMARY OF THE INVENTION

An embodiment of a system communicating processors is provided. The system comprises a first processor, a second processor, a SRAM and a DMA unit. The DMA unit further comprises a detection unit to determine whether the SRAM is accessed by the second processor, wherein when the SRAM is not accessed by the second processor, the access control of the SRAM is transferred to the DMA unit, and data communication between the first processor and the second processor is transmitted by the DMA unit.

An embodiment of a method for issuing a command from a first processor to a second processor is provided. The method comprises setting a start address of a SRAM by the first processor, transmitting the command to a buffer, clearing a command finish flag; trigger a DMA unit to move the command to the SRAM when the SRAM is not accessed, reading the command from the SRAM and asserting the command finish flag by the second processor when the command is completely processed.

An embodiment of a method for a first processor reading data from a SRAM is provided, wherein the SRAM is accessed by a second processor. The method comprises setting a data length, setting a start address of the SRAM, triggering a DMA unit to move the data from the SRAM to a buffer when the SRAM is not accessed, polling a status bit to determine whether the data is completely read and reading the data from a data buffer when the status bit is at a first state.

An embodiment of a method for a first processor writing data to a SRAM is provided, wherein the SRAM is accessed by a second processor. The method comprises setting a data length, setting a start address of the SRAM, transmitting the data to a buffer and triggering a DMA unit to move the data to the SRAM when the SRAM is not accessed.

An embodiment of a system communicating between processors is provided. The system comprises a first processor, a second processor comprising an internal memory, a DMA unit. The DMA unit comprises a detection unit detecting a chip select signal indicating whether the internal memory is accessed by the second processor. When the first processor accesses the internal memory, the first processor transmits a start address and data length to the DMA unit. The DMA unit then reads and transmits data from the internal memory according to the start address and the data length to a buffer. The first processor then reads the data from the buffer.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is schematic block diagram of an embodiment of a communication system between two processors according to the invention.

FIG. 2 is a schematic block diagram of an embodiment of an optical drive according to the invention.

FIG. 3 is a flowchart of an embodiment of a communication method between processors according to the invention.

FIG. 4 is a flowchart of another embodiment of a communication method between processors according to the invention.

FIG. 5 is a flowchart of another embodiment of a communication method between processors according to the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

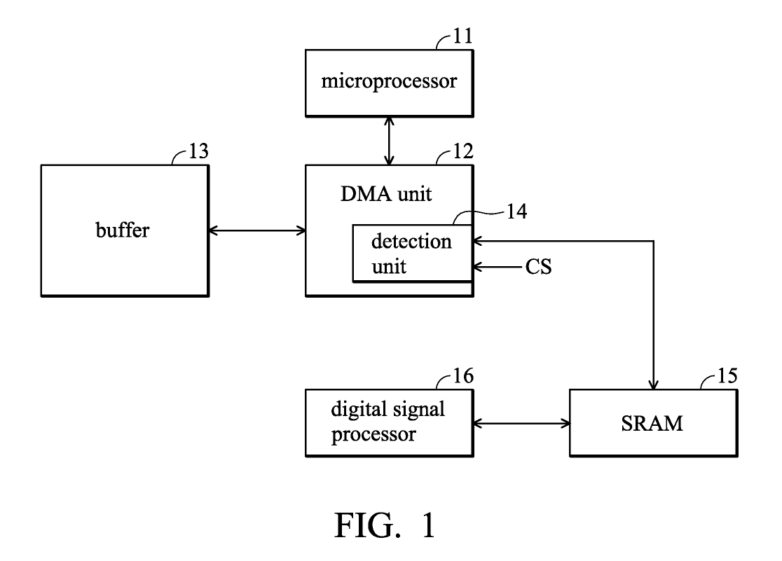

An embodiment of a system communicating two processors is illustrated with FIG. 1. The system comprises a microprocessor 11, a DMA (direct memory access) unit 12 having a detection unit 14, a buffer 13, a SRAM 15 and a digital signal processor 16. The detection unit detects whether the SRAM 15 is accessed by the digital signal processor 16 by monitoring the state of the signal CS. When the microprocessor 11 wants to write data to the SRAM 15, the microprocessor 11 first transmits the data to the buffer 13 through the DMA unit 12, and informs the DMA unit 12 the start address of the SRAM 15, the data length, and the read/write direction R/W. The read direction indicates that the microprocessor 11 reads data from the SRAM 15. The write direction indicates that the microprocessor 11 writes data to the SRAM 15.

The start address is predetermined based on the transmission standard or the transport protocol between the microprocessor 11 and the digital signal processor 16. The data length indicates the number of piece of data to be accessed. When the DMA unit 12 receives the start address and the data length, the detection unit 14 monitors the chip select signal, and when the chip select signal CS is at first state, for example logic 0, the DMA unit 12 transmits the data to the SRAM 15. During the transmission between the DMA unit 12 and SRAM 15, one busy bit is asserted to indicate the transmitting state and when the data transmission is finished, the busy bit is cleared.

In this embodiment, the buffer size is adjustable, and one buffer corresponds to one address of SRAM 15. For example, if the microprocessor 11 has two pieces of data to be transmitted to the SRAM 15, the two pieces of data are respectively stored in two buffers. One piece of data is stored to start address of the SRAM, and the other piece of data is stored to the address next to the start address of the SRAM. In this embodiment, a chip select signal CS is applied to determine whether the SRAM 15 is accessed by the digital signal processor 16. In another embodiment, the detection unit 14 can monitor one signal of the digital signal processor 16 or the SRAM 15 to determine whether the SRAM 15 is accessed by the digital signal processor 16. It is noted that the chip select signal CS is generated by a device built in the system, such as a SRAM controller (not shown).

When the microprocessor 11 wants to issue a command to the digital signal processor 16, the microprocessor 11 first transmits the command to the buffer 13 through the DMA unit 12, and informs the DMA unit 12 the start address of the SRAM 15 and the data length. When the DMA unit 12 receives the start address and the data length, the detection unit 14 monitors the chip select signal CS. Then, when the chip select signal CS is at first state, for example logic 0, the DMA unit 12 transmits the data to the SRAM 15 and asserts one bit to inform the digital signal processor 16 for receiving the command, wherein the bit can be the bit of the start address.

Accordingly, the digital signal processor 16 has to continue or periodically to poll the bit to determine whether the microprocessor 11 issues command to the digital signal processor 16. When the digital signal processor 16 detects that the microprocessor 11 issues command to the digital signal processor 16, the digital signal processor 16 acquires data from SRAM 15 and de-asserts the bit after the command is completely acquired. The digital signal processor 16 then parses the command, checks the parameter length and executes corresponding operation. After the digital signal processor 16 finishes processing the command, a command finish bit is asserted to inform the microprocessor 11 that the digital signal processor 16 is ready for another command.

When the microprocessor 11 wants to read parameters from the SRAM 15, the microprocessor 11 informs the DMA unit 12 the data address of the SRAM 15 and the data length. The detection unit 14 monitors the chip select signal CS, and when the chip select signal CS is at first state, for example logic 0, the DMA unit 12 transmits the data at corresponding address of the SRAM 15 to the buffer 13. During the transmission between the buffer 13 and SRAM 15, one busy bit is asserted and when the data transmission is finished, the busy bit is cleared. The microprocessor 11 polls the busy bit and acquires desired data from the buffer when the busy bit is at logic 0.

The buffer 13 here is used to assist the microprocessor 11 in reading data from the SRAM 15. It is noted that the buffer 13 can also be built in the DMA unit 12 in some embodiments (not shown).

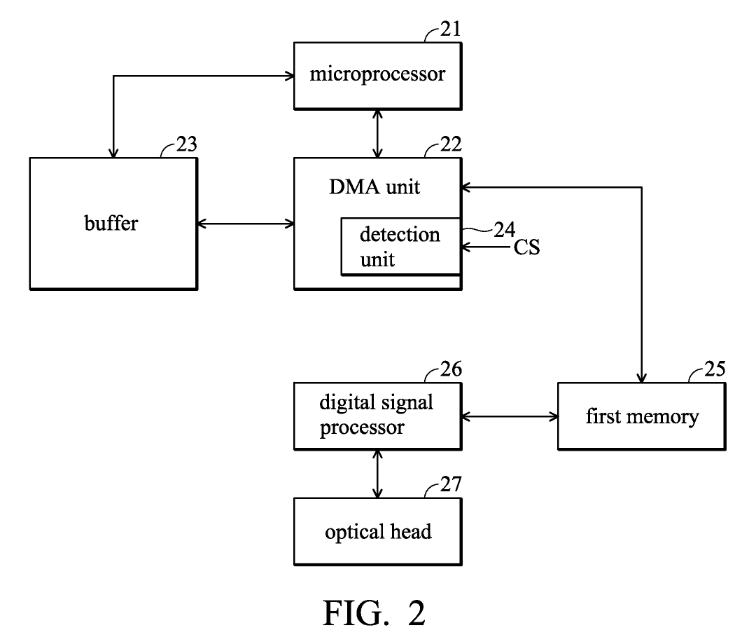

FIG. 2 is a schematic block diagram of an embodiment of an optical drive according to the invention. The system comprises a microprocessor 21, a direct memory access (DMA) unit 22 having a detection unit 24, a buffer 23, a digital signal processor 26 and a first memory 25. The detection unit detects whether the first memory 25 is accessed by the digital signal processor 26 by monitoring the state of the signal CS. The digital signal processor 26 controls the optical head 27 to access an optical storage medium. The optical head 27 stores the accessed data from the optical storage medium to the first memory 25.

When the microprocessor 21 wants to write data to the first memory 25, the microprocessor 21 first transmits the data to the buffer 23 and informs the DMA unit 22 the start address of the first memory 25, the data length, and the read/write direction R/W. When the DMA unit 22 receives the start address and the data length, the detection unit 24 monitors the chip select signal CS, and when the chip select signal CS is at first state, for example logic 0, the DMA unit 22 transmits the data to the first memory 25. During the transmission between the DMA unit 22 and first memory 25, one busy bit is asserted and when the data transmission is finished, the busy bit is cleared.

When the microprocessor 21 wants to issue a command to the digital signal processor 26, the microprocessor 21 first transmits the command to the buffer 23 and informs the DMA unit 22 the start address of the first memory 25 and the data length. When the DMA unit 22 receives the start address and the data length, the detection unit 24 monitors the chip select signal CS, and when the chip select signal CS is at first state, for example logic 0, the DMA unit 22 transmits the data to the first memory 25 and asserts one bit to inform the digital signal processor 16 for receiving the command, wherein the bit may be the bit of the start address.

Accordingly, the digital signal processor 26 has to continue or periodically to poll the bit to determine whether the microprocessor 21 issues command to the digital signal processor 26. When the digital signal processor 26 detects that the microprocessor 21 issues command to the digital signal processor 26, the digital signal processor 26 acquires data from SRAM 15 and de-asserts the bit after the command is completely acquired. The digital signal processor 26 then parses the command, checks the parameter length and executes corresponding operation. After the digital signal processor 26 finishes processing the command, a command finish bit is asserted to inform the microprocessor 21 that the digital signal processor 26 can process another command.

When the microprocessor 21 wants to read parameters from the first memory 25, the microprocessor 21 informs the DMA unit 22 the data address of the first memory 25 and the data length. The detection unit 24 monitors the chip select signal CS, and when the chip select signal CS is at first state, for example logic 0, the DMA unit 22 transmits the data at corresponding address of the first memory 25 to the buffer 23. During the transmission between the buffer 23 and first memory 25, one busy bit is asserted and when the data transmission is finished, the busy bit is cleared. The microprocessor 21 polls the busy bit and acquires desired data from the buffer when the busy bit is at logic 0.

When the microprocessor 21 wants to read data from the optical storage medium (not shown), the microprocessor 21 first issues a command to the digital signal processor 26. The digital signal processor 26 stores the accessed data from the optical storage medium to the first memory 25 at a predetermined address, and the microprocessor 21 read the data stored in the first memory 25 according to the description above.

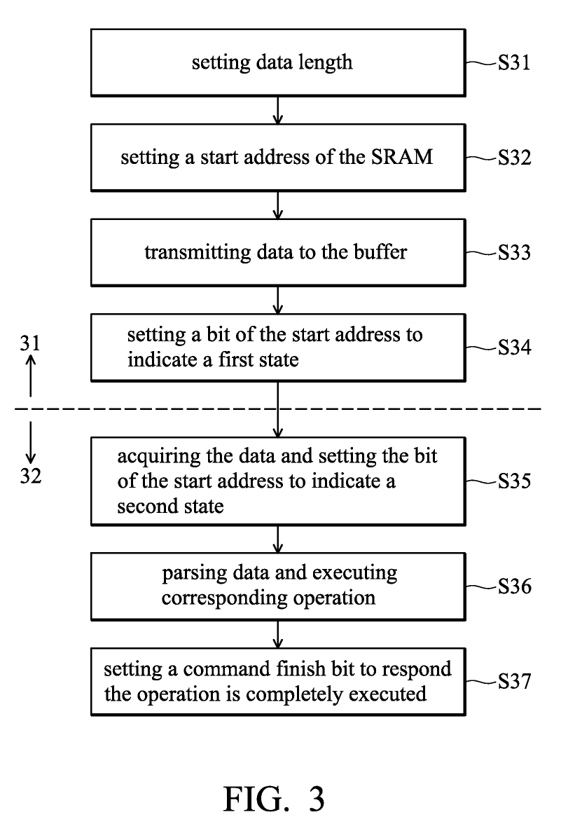

FIG. 3 is a flowchart of an embodiment of a communication method between processors according to the invention. The flowchart shows the operation when the microprocessor wants to issue command to the digital signal processor. The flowchart in FIG. 3 can be read with the system shown in FIG. 1 or FIG. 2. The flowchart in FIG. 3 mainly comprises two parts, the procedure 31 relates to the operation of microprocessor and the procedure 32 directs to the operation of the digital signal processor. In step S31, the microprocessor sets the data length. In step S32, the microprocessor sets a start address of the SRAM associated with the digital signal processor. In step S33, the microprocessor transmits the command to the buffer. In step S34, the microprocessor sets a bit of the start address to indicate a first state when the command is completely transmitted to the first memory associated with the digital processor. In step S35, when the digital signal processor detects that the microprocessor issues command to the digital signal processor, the digital signal processor acquires data from first memory and de-asserts the bit after the command is completely acquired. In step S36, the digital signal processor then parses the command, checks the parameter length and executes corresponding operation. In step S37, after the digital signal processor finishes processing the command, a command finish bit is asserted to inform the microprocessor that the digital signal processor can process another command.

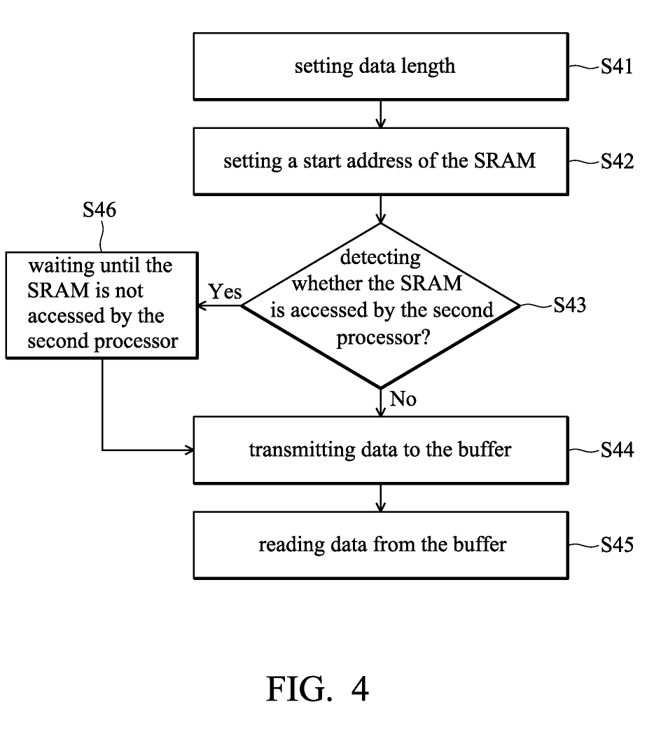

FIG. 4 is a flowchart of another embodiment of a communication method between processors according to the invention. The flowchart shows the operation when the microprocessor wants to read data from the SRAM of the digital signal processor. In step S41, the microprocessor sets the data length. In step S42, the microprocessor sets a start address of the SRAM associated with the digital signal processor. In step S43, the detection unit of the DMA unit detects whether the SRAM is accessed by the second processor. If the SRAM is accessed by the second processor, the procedure jumps to step S46 to wait until the SRAM is not accessed by the second processor. In the step S46, if the SRAM is not accessed by the second processor, the procedure jumps to the step S44. In step S44, the DMA unit reads the data from the SRAM and transmits the read data to the buffer. During the transmission between the buffer and first memory, one busy bit is asserted and when the data transmission is finished, the busy bit is cleared. In step S45, the microprocessor reads the data from the buffer when the busy bit is cleared.

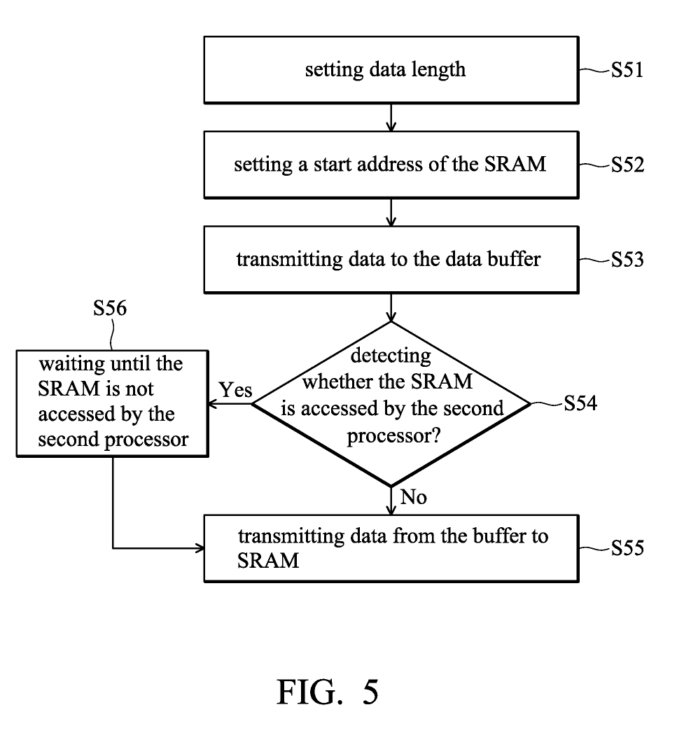

FIG. 5 is a flowchart of another embodiment of a communication method between processors according to the invention. The flowchart shows the operation when the microprocessor wants write data to the SRAM of the second processor. In step S51, the microprocessor sets the data length. In step S52, the microprocessor sets a start address of the SRAM associated with the digital signal processor. In step S53, the microprocessor transmits and stores data in a buffer. In step S54, the detection unit of the DMA unit detects whether the SRAM is accessed by the second processor. If the SRAM is accessed by the second processor, the procedure jumps to step S56 to wait until the SRAM is not accessed by the second processor. In the step S56, if the SRAM is not accessed by the second processor, the procedure jumps to the step S55. In step S55, the DMA unit directly transmits the data from buffer to the SRAM.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A system communicating processors, comprising
a first processor;
a second processor;
a SRAM; and
a DMA unit, comprising:
a detection unit to determine whether the SRAM is accessed by the second processor;
wherein when the SRAM is not accessed by the second processor, the access control of the SRAM is transferred to the DMA unit, and data communication between the first processor and the second processor is transmitted by the DMA unit.

2. The system as claimed in claim 1, wherein when the second processor issues an access request to the SRAM, the access control of the SRAM is transferred to the second processor.

3. The system as claimed in claim 1, further comprising a buffer coupled to the first processor and the DMA unit for temporarily storing data transmitted to/from the SRAM.

4. The system as claimed in claim 3, wherein the buffer is built in the DMA unit.

5. The system as claimed in claim 1, further comprising a chip select signal indicating the status of the SRAM, and the detection unit detecting the chip select signal to determine whether the SRAM is accessed by the second processor.

6. The system as claimed in claim 1, wherein the first processor is a microprocessor.

7. The system as claimed in claim 1, wherein the second processor is a digital signal processor.

8. The system as claimed in claim 1, further comprises an optical head controlled by the second processor to access an optical storage medium.

9. A method for issuing a command from a first processor to a second processor, comprising:
setting a start address of a SRAM by the first processor;
transmitting the command to a buffer, and clearing a command finish flag;
triggering a DMA unit to move the command to the SRAM when the SRAM is not accessed.
reading the command from the SRAM and asserting the command finish flag by the second processor when the command is completely processed.

10. The method as claimed in claim 9, wherein the second processor polling a bit of a start address, acquiring a data from the start address when the bit is asserted, clearing the bit after the command is completely transmitted to the second processor, parsing the data and executing an operation carried by the command.

11. The method as claimed in claim 10, after executing the operation, further comprising outputting a command finish signal or preparing data for the first processor.

12. A method for a first processor reading data from a SRAM, wherein the SRAM is accessed by a second processor, comprising:
setting a data length;
setting a start address of the SRAM;
triggering a DMA unit to move the data from the SRAM to a buffer when the SRAM is not accessed;
polling a status bit to determine whether the data is completely read; and
reading the data from a data buffer when the status bit is at a first state.

13. The method as claimed in claim 12, further comprising executing a direct memory access operation, and pausing the direct memory access operation when the SRAM is accessed.

14. A method for a first processor writing data to a SRAM, wherein the SRAM is accessed by a second processor, comprising:
setting a data length;
setting a start address of the SRAM;
transmitting the data to a buffer; and
triggering a DMA unit to move the data to the SRAM when the SRAM is not accessed.

15. The method as claimed in claim 14, further comprising executing a direct memory access operation, and pausing the direct memory access operation when the SRAM is accessed.

16. A system communicating between processors, comprising:
a first processor;
a second processor comprising an internal memory;
a DMA unit comprising:
a detection unit detecting a chip select signal indicating whether the internal memory is accessed by the second processor, wherein
when the first processor accesses the internal memory, the first processor transmits a start address and data length to the DMA unit, the DMA unit reads and transmits data from the internal memory according to the start address and the data length to a buffer, and the first processor reads the data from the buffer.

17. The system as claimed in claim 16, wherein when the second processor polls a bit of the start address to determine whether the first processor issues a command to the second processor.

18. The system as claimed in claim 16, wherein when the first processor writes data to the internal memory, the first processor transmits the data to the buffer and a second address and data length to the DMA unit, and the DMA unit moves data from the buffer to the internal memory when the internal memory is not accessed by the second processor.
